(19) United States
(12) Patent Application Publication
(10) Pub. No.: US 2007/0220149 A1
(43) Pub. Date: Sep. 20, 2007

(54) Load balance control method and load balance control apparatus in data-processing system

(76) Inventors: Masanori Kawashima, Yokohama (JP); Tatsuya Yamaguchi, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/482,724

(22) Filed: Jul. 10, 2006

(30) Foreign Application Priority Data
Mar. 15, 2006 (JP) 2006-070175

(51) Int. Cl. G06F 15/173

(52) U.S. Cl. 709/226

(57) ABSTRACT

The delay of an ongoing configuration change process, which may result from resource insufficiency, is restrained to avoid a great difference between the actual load condition and the load condition predicted before a configuration change, and provide proper service arrangement. A load distribution control device distributes the requests received from client terminals to a plurality of server nodes in order to distribute the load on the server nodes. A configuration change device calculates necessary resource amounts when a configuration change involving a service-start or service-stop is to be made. The load distribution control device references a load management table and allocates necessary amounts of resources to a server node that requires the calculated resource amounts. Subsequently, the configuration change device effects the configuration change.

### CLAIM OF PRIORITY

The present application claims priority from the Japanese patent application JP2006-070175 filed on Mar. 15, 2006, the content of which is hereby incorporated by reference into this application.

### BACKGROUND OF THE INVENTION

The present invention relates to a cluster system that comprises a plurality of computers, and more particularly to a load distribution control technology for exercising control to provide proper service arrangement in accordance with the load conditions for server nodes constituting the cluster system and for operating services.

In recent years, various business processing systems such as a bullet train reservation system, airline reservation system, and electronic business transaction system are offered via the Internet as a Web service. When such an application system increases in number, the number of application system users increases. As a result, the employed server is frequently accessed (that is, an increased number of processing requests are generated by clients). Such a frequent access drastically increases the load on the server. This decreases the processing speed. In the worst case, the system comes to an abnormal stop.

A software technology called a cluster system is used to avoid the above problem. The cluster system enhances the processing performance and reliability of services to be offered to clients (users) by managing a computer system comprising a plurality of computers (e.g., server computers) and by executing application programs. Further, the cluster system increases the availability and achieves load distribution because it is capable of scheduling services running on a computer system for use on an optimum computer when a computer starts up or becomes faulty or the load condition changes.

Technologies concerning the cluster system described above are disclosed by Japanese Patents JP-A No. 163241/2002, JP-A No. 31736/2005, JP-A No. 100387/2005, and JP-A No. 135125/2005.

### SUMMARY OF THE INVENTION

When a conventional technology is used, it is necessary to prepare auxiliary servers that might not be used. Therefore, additional cost is involved for system construction, maintenance, and management. This problem can be eased by judging the load condition for services and applying a configuration change, for instance, to replace a nonparticular service running on a server with a particular service. Further, it is possible to implement a cluster system that can exercise service policy management (e.g., priority and service relationship (exclusion or dependence) management) to properly make an optimum service configuration change in accordance with a service execution condition such as a dynamic load condition change after optimum service arrangement.

In many cases, however, the configuration change process for optimum service arrangement does not take the load on server nodes into account. Therefore, the following problems may occur because a configuration change process load is imposed on server nodes.

(1) Because of the load imposed by a configuration change process, the time of configuration change process completion may be delayed from a scheduled time. Therefore, it can be anticipated that the load condition prevailing upon completion of a configuration change may be greatly different from the load condition that was predicted when the configuration change was judged to be necessary. In other words, the service arrangement prevailing after the configuration change may not already be optimized.

(2) Because of the load imposed by a configuration change process, the load balance may be disturbed although it has been properly maintained by load distribution control. Consequently, the service process for clients may become delayed, thereby affecting the service quality.

The present invention relates to a cluster system in which a plurality of business programs run on a plurality of server nodes to offer services, and more particularly to a load distribution control technology for distributing requests received from client terminals to the plurality of server nodes with a view toward distributing the load on each server node.

A computer, which exercises load distribution control in accordance with the present invention, calculates the required amounts of resources when a configuration change is applied in relation to the start or stop of services, examines a server node that requires the calculated amounts of resources, and judges whether any resources are insufficient for configuration change processing. If any resources are insufficient, the computer allocates the required amounts of resources and then makes a configuration change.

The computer, which exercises load distribution control as described above, retains load management information that records the use of each type of resource in relation to various combinations of running service identifiers and server node identifiers. As the load management information, a basic load value may be set for each type of resource in relation to the use of resources. When the required amounts of resources are to be allocated, the computer, which exercises load distribution control, performs setup so as to decrease the basic load value in accordance with the required resource amount for services running on a server node that requires resources for a configuration change, and restores the decreased basic load value to the original value after the configuration change.

According to an aspect of the present invention, the basic load value decrease is allotted to a running service in accordance with the request amount throughput and service priority.

According to an aspect of the present invention, the load distribution control computer (load balancer) is separated into a load distribution control device and a configuration change device. The load distribution control device handles a plurality of services that are executed by various server nodes, compares the individual service load conditions against the basic load value for each service, and determines an optimum service that is to be allotted in compliance with a request from a client. Further, the load distribution control device issues a configuration change instruction to a target server node so as to optimize the service arrangement for the server node. The configuration change device performs a configuration change process on a target service in compliance with a configuration change instruction from the load distribution control device. The configuration change device calculates the amounts of resources (including the amounts of CPU, memory, and disk use) required for a configuration change, and notifies the load distribution control device of the calculated resource amount. The load distribution control device receives the information about the required resource amount, and temporarily changes the threshold value for the basic load for each service in accordance, for instance; with service priority.

The cluster system according to the present invention can reduce the possibility of a process delay, which may be caused by resource insufficiency in a configuration change process, and promptly perform the configuration change process.

Further, the delay of the configuration change process can be restrained to avoid a great difference between the actual load condition and the load condition predicted when a configuration is judged to be necessary. Thus, predicted services can be properly arranged when the process is completed.

According to an aspect of the present invention, the amounts of resources required for a configuration change process can be calculated in advance to decrease the basic load value so that a service running during configuration change process execution bears the required resource amount in accordance with the request amount throughput and service priority. Consequently, the existing load balance can be maintained during configuration change process execution to steadily offer services to clients.

### BRIEF DESCRIPTION OF THE DRAWINGS

FIG. 1 is a block diagram illustrating a cluster system according to an embodiment of the present invention;

FIG. 2 is a flowchart illustrating processing operations that are performed by a load distribution control device and a configuration change device, which are included in the system;

FIG. 3 illustrates a typical data structure of configuration change instruction information that the load distribution control device conveys to the configuration change device;

FIG. 4 illustrates a typical data structure of a resource amount management table;

FIG. 5 illustrates a typical data structure of resource amount calculation result information;

FIG. 6 is a flowchart illustrating the processing steps to be performed to calculate the amounts of resources required for a configuration change process;

FIG. 7 shows a typical result of calculations that are performed to determine the amounts of resources required for a configuration change process;

FIG. 8 shows a typical data structure of a load management table;

FIG. 9 is a flowchart illustrating the processing steps to be performed to change a basic load value for a particular service;

FIG. 10 is a block diagram illustrating the configuration of another cluster system;

FIG. 11 shows another typical data structure of configuration change instruction information;

FIG. 12 shows another typical data structure of resource amount calculation result information;

FIG. 13 is a flowchart illustrating other processing operations that are performed by the load distribution control device and the configuration change device; and

FIG. 14 shows a typical data structure of the basic load information to be changed.

### DETAILED DESCRIPTION OF THE PREFERRED EMBODIMENT

An embodiment of a cluster system according to the present invention will now be described with reference to the accompanying drawings.

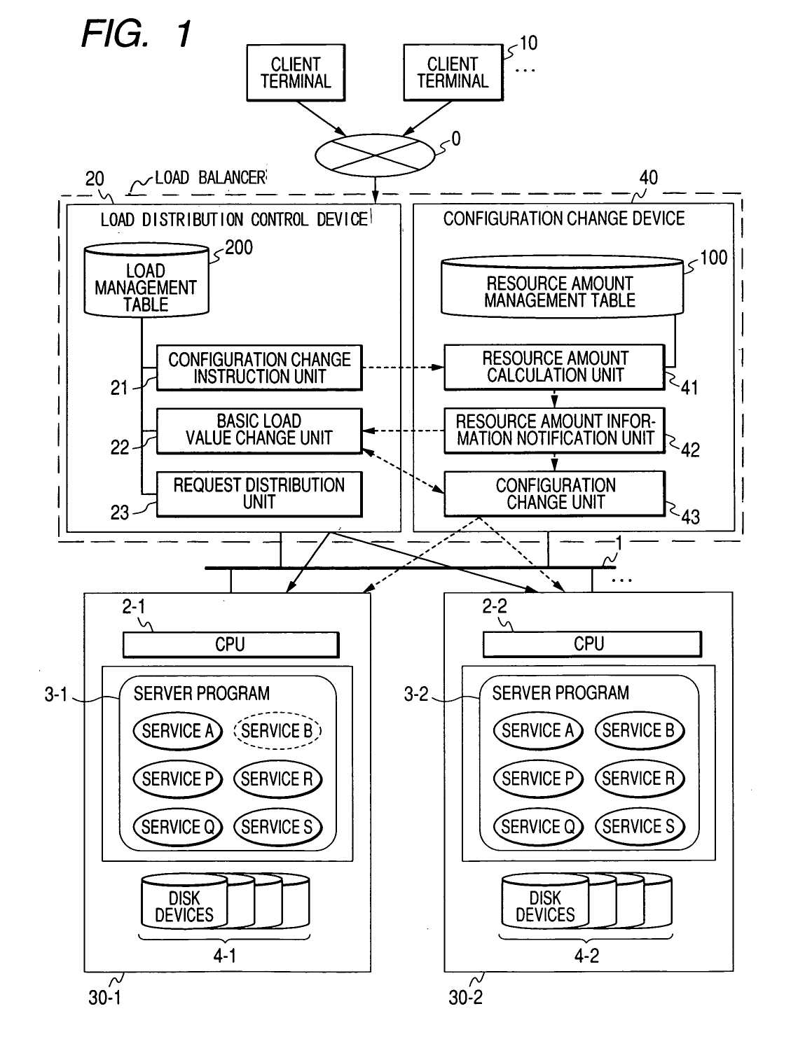

FIG. 1 illustrates the overall configuration of the cluster system according to the present embodiment. The cluster system includes client terminals 10, a load distribution control device 20, server nodes 30-1, 30-2, . . . , and a configuration change device 40. The client terminals 10 can communicate with the load distribution control device 20 via network 0. The other devices can communicate with each other via network 1.

Each server node is a von Neumann computer system that includes a CPU 2, a memory 3, and disk devices 4. Services A, B, P, Q, R, and S which are shown in the figure, are business programs that offer various services. These business programs are executed under the control of a server program 3, which is installed on each server node. Application servers such as the OLTP (Online Transaction Processing) and J2EE (Java2 Platform, Enterprise Edition (registered trademark of Sun Microsystems)) servers are used as the server program. The server program and business programs are stored on the disk devices 4 or other external storage devices, loaded into the memory 3 as needed, and executed by the CPU 2. In this document, the numerals attached to the reference numerals are omitted when a certain device is designated.

Each client terminal 10 is a computer that incorporates a Web browser or Web server, accesses a server node 30 via network 0 such as the Internet, and makes a request for a service. The services requested by the client terminal 10 include, for instance, viewing/listening to various pieces of content such as text, images, and music, product ordering, ticket reservation, and bank account balance transfer.

The load distribution control device 20 is a computer that has a load management table 200, a configuration change instruction unit 21, a basic load value change unit 22, and a request distribution unit 23. The load distribution control device 20 includes a CPU, memory, and other storage device. The load management table 200 is stored in a storage device, and stores a basic load value and the information that indicates the current resource use by server nodes on an individual service basis. The configuration change instruction unit 21, basic load value change unit 22, and request distribution unit 23 are programs stored in the memory and executed by the CPU.

The request distribution unit 23 receives requests from various client terminals 10, references the load management table 200, and distributes the received requests to a service that is running on a certain server node 30 so that the loads on the server nodes 30 are virtually equalized. If the resource use of a certain service exceeds the basic load value, the request distribution unit 23 distributes the associated request to another server node 30 on which the same service runs. The access destination address of a determined server node 30 is designated by using, for example, an access destination search function of JNDI (Java Naming and Directory Interface (registered trademark of Sun Microsystems)), which is a naming service. In FIG. 1, the solid line arrows indicate flows of request and the dotted line arrows indicate flows of control.

The configuration change instruction unit 21 references the load management table 200, checks the basic load value and resource use of each service, and judges whether a service-related configuration change is needed. If the obtained judgment result indicates that such a configuration change is needed, the configuration change instruction unit 21 issues a configuration change instruction to the configuration change device 40.

The basic load value change unit 22 changes the basic load value in the load management table 200 in accordance, for instance, with a configuration change.

The load distribution control device 20 may be incorporated in a certain server node 30 or may exist as a server computer that is independent of a server node 30.

The configuration change device 40 is a computer that has a resource amount management table 100, a resource amount calculation unit 41, a resource amount information notification unit 42, and a configuration change unit 43. The configuration change device 40 includes a CPU, memory, other storage device, input device, and display device. The resource amount management table 100 is stored in a storage device, and stores the information about the amounts of resources required, for instance, for a configuration change. The resource amount calculation unit 41, resource amount information notification unit 42, and configuration change unit 43 are programs stored in the memory and executed by the CPU.

The configuration change unit 43 issues a service-related configuration change instruction, which relates, for instance, to the start or stop of a service to a target server node 30 after resources required for a configuration change are allocated by the load distribution control device 20. Each server node 30 incorporates a program for changing the configuration of a designated service, and makes a configuration change in compliance with the instruction.

The resource amount calculation unit 41 receives a configuration change request designated by an operational command, which is issued by the load distribution control device 20 or input device, references the resource amount management table 100, and calculates the amounts of resources required for a designated configuration change process. The resource amount information notification unit 42 notifies the load distribution control device 20 of a calculated resource amount.

The configuration change device 40 may be incorporated in each server node 30 or may exist as a server computer that is independent of the server nodes 30. If the configuration change device 40 is incorporated in a server node 30, it uses the CPU, memory, other storage device, input device, and display device of the server node 30. If the configuration change device 40 is an independent server computer, it may be incorporated in a single server computer as a device that is coexistent with the load distribution control device 20 or as a load distribution control device that is integral with the load distribution control device 20.

Some of the processing requests to be sent to the server nodes 30 are delivered via the load distribution control device 20, while others are not. As a processing request that is delivered via the load distribution control device 20, a request may be sent from a client. As a processing request that is not delivered via the load distribution control device 20, a configuration change instruction may be sent from the configuration change device 40. Further, an operational request may also be sent from an operational computer (not shown) to the server node 30. As regards the processing requests delivered via the load distribution control device 20 and the processing requests delivered not via the load distribution control device 20, the present embodiment can therefore control and balance the loads on individual server nodes 30.

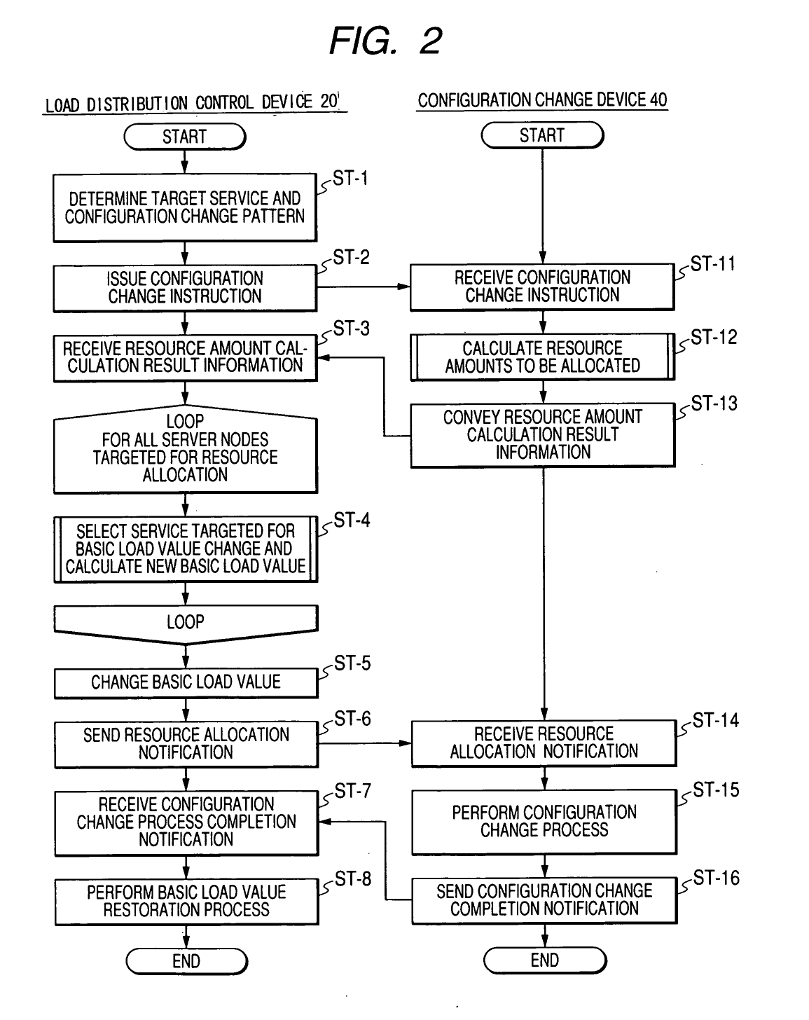

The processing steps to be performed by the load distribution control device 20 and configuration change device 40 will now be described with reference to a flowchart in FIG. 2.

First of all, the configuration change instruction unit 21 references the load management table 200 to judge whether any service requires a configuration change. When a target service is determined, a configuration change pattern is determined (step ST-1). For example, there are the following configuration change patterns:

### (1) Replacing service A on server node 30-1 by service B

### (2) Adding service A to server node 30-1

### (3) Stopping service A on server node 30-1

### (4) Switching service A on server node 30-1 over to server node 30-2

### (5) Changing the degree of multiprocessing of service A on server node 30-1

If, for instance, the amount of requests for service A on server node 30-1 tends to decrease while the amount of request for service B on another server node 30 increases, a configuration change needs to be made in accordance with pattern 1.

Next, the configuration change instruction unit 21 issues a configuration change instruction to the configuration change device 40 (step ST-2). The configuration change instruction according to the present invention contains information that indicates a configuration change pattern (one of patterns 1 to 5).

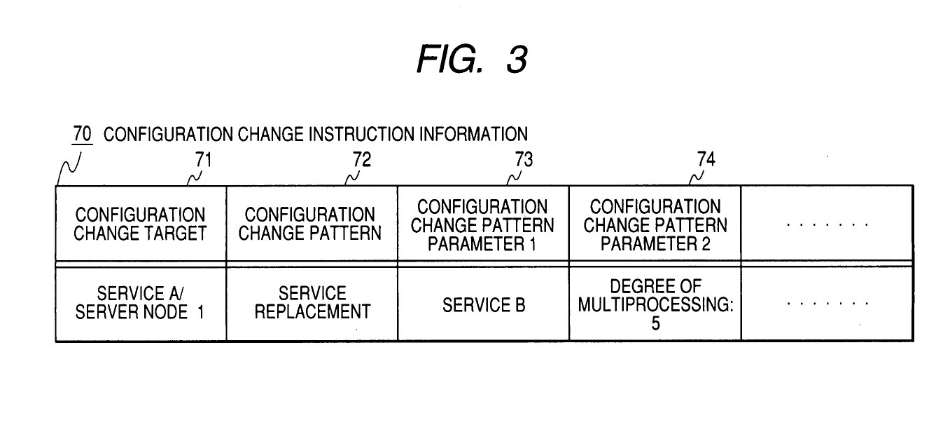

FIG. 3 shows a typical format of configuration change instruction information 70. The configuration change instruction information 70 shown in FIG. 3 includes a configuration change target 71, a configuration change pattern 72, configuration change pattern parameter 1 (73), and configuration change pattern parameter 2 (74).

As regards pattern 1, “service A/server node 1”, which runs on server node 30-1, is stored as the configuration change target 71; “service replacements” is stored as the configuration change pattern 72; “service B” is stored as configuration change pattern parameter 1 (73), which indicates the service name targeted for replacement; and the “degree of multiprocessing” of service B is stored as configuration change pattern parameter 2 (74). As regards patterns 2 and 3, “service addition” or “service stop” is set as the configuration change pattern 72. As regards pattern 4, “system change” is stored as the configuration change pattern 72; and a movement destination server node name is stored as configuration change pattern parameter 1 (73). As regard pattern 5, “degree-of-multiprocessing change (increase/decrease)” is stored as the configuration change pattern 72; and an increase or decrease in the degree of multiprocessing is stored as configuration change pattern parameter 1 (73).

The resource amount calculation unit 41 receives the configuration change instruction (step ST-11), references the resource amount management table 100, and calculates the resource amount required for a configuration change from a designated configuration change pattern (step ST-12). The procedure performed in these steps will be described in detail later. Next, the resource amount information notification unit 42 notifies the load distribution control device 20 of the calculation result information about the resource amount to be allocated (step ST-13).

The basic load value change unit 22 receives the resource calculation result information (step ST-3), selects the target service to be subjected to a basic load value change in order to allocate the resources for a server node 30 that makes a configuration change, and calculates a new basic load value for the target service (step ST-4). The basic load value change unit 22 repeatedly performs step ST-4 for each of the server nodes targeted for resource allocation. The procedure performed in step ST-4 will be described in detail later.

Next, the basic load value change unit 22 changes the associated basic load value in the load management table 200 in accordance with the new basic load value for the target service, which was calculated in step ST-4 (step ST-5). The basic load value change unit 22 then notifies the configuration change device 40 that the resource amount required for a configuration change is allocated by changing the basic load value (step ST-6). A time delay may arise between the instant at which the basic load value is changed and the instant at which available resources are allocated for the target server node for configuration change purposes. Therefore, the basic load value change unit 22 may wait for a certain period of time and then notify the configuration change device 40 of resource allocation.

The configuration change unit 43 receives the resource allocation notification step (step ST-14), and applies a service-related configuration change in accordance with the configuration change pattern received in step ST-11 (step ST-15). The configuration change device 40 retains a list of commands for configuration change execution, and transmits the associated command to the target server node 30. If, for instance, configuration change pattern 4 is employed, the scheduled change-over command offered by common cluster software may be used. When the configuration change is completed, the configuration change unit 43 notifies the load distribution control device 20 of configuration change completion (step ST-16).

The basic load value change unit 22 receives the notification (step ST-7), references the load management table 200, and restores the basic load value, which was changed in step ST-5, to the value prevailing before the change (step ST-8). While steps ST-2 to ST-8 are being performed, the load distribution control device 20 does not start the next configuration change process.

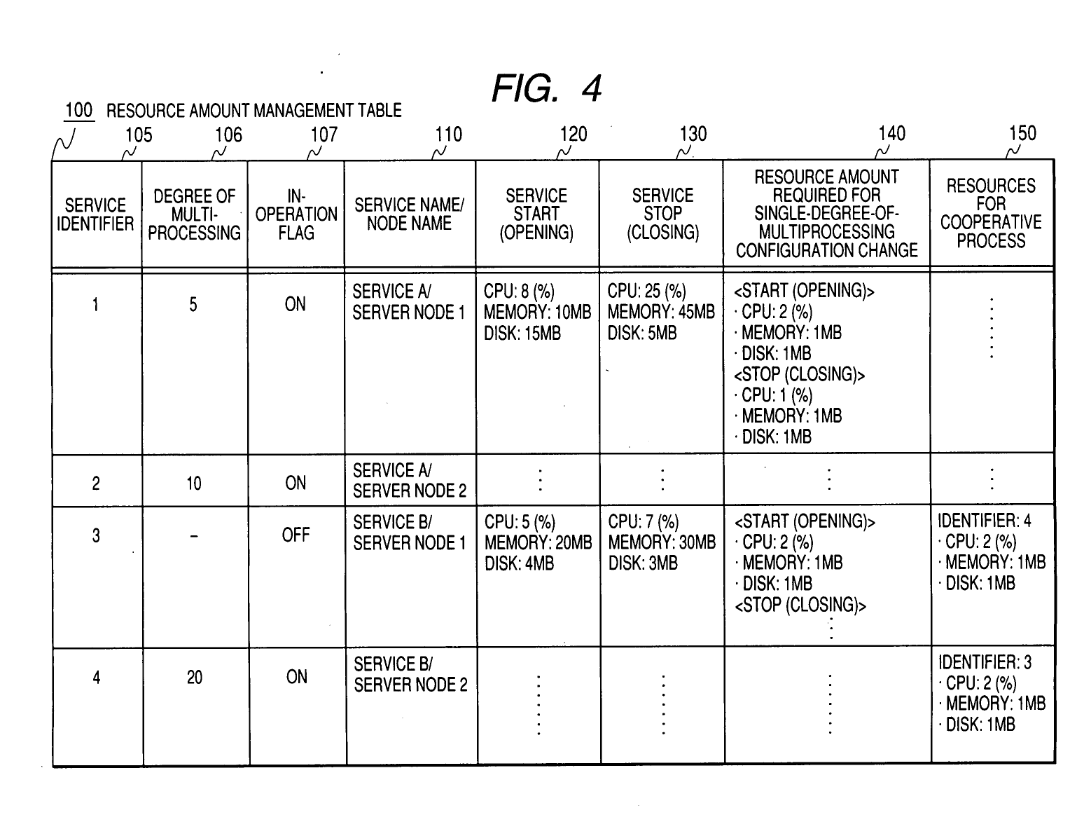

FIG. 4 shows a typical data structure of the resource amount management table 100. The service identifier 105 is an identifier that is given to the combination of a service name and server node name. The degree of multiprocessing 106 indicates the degree of multiprocessing of a running service. The degree of multiprocessing denotes the number of processes currently executed for the same service, and corresponds to the number of requests that are processed in a parallel manner. The in-operation flag 107 indicates whether the service is running (ON) or not (OFF). The service name/node name 110 is the combination of the name of a service and the server node name of a server node in which the service runs. The service start 120 is used to set the resource amount required for service startup on an individual resource basis. The disk use amount may be indicated in the form of utilization ratio instead of storage capacity. This also holds true for the other disk use amounts. The service stop 130 is used to set the resource amount that is required to stop the service. The resource amount required for single-degree-of-multiprocessing configuration change 140 denotes the resource amount that is required per one degree of multiprocessing at the time of service start/stop.

The resources for cooperative process 150 is used, in a situation where a cooperative process is additionally performed in coordination with another server node at the time of a configuration change, to set a cooperative service identifier 105 and the resource amount required for such processing. When, for instance, the service to be newly started takes over the session information about another server node that runs the same service or some other information stored in the memory, or when the information about a session is to be duplexed, an additional resource amount is necessary. Here, the term “session” denotes a session that is established between a client terminal 10 and a running service. The session information is duplexed to furnish another server node with the session information to perform failover. When a certain server node 30 starts a service in this instance, the business program for the service needs to establish a session with a business program that provides the same service on another server node. The resources for cooperative process 150 are necessary when such an inter-service session is to be established.

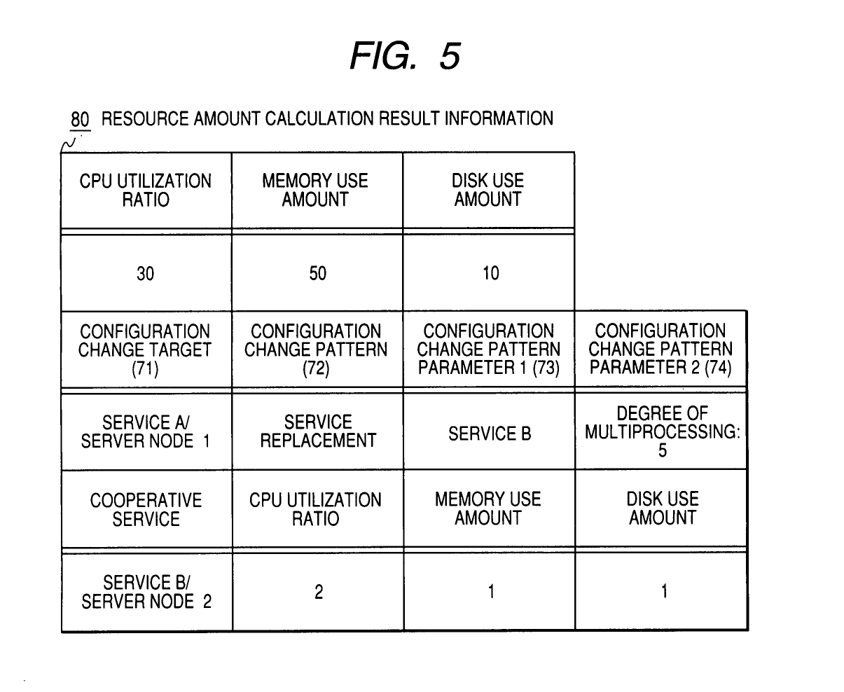

FIG. 5 shows a typical data structure of resource amount calculation result information 80. The resource amount calculation result information 80 contains the amounts of resources (CPU utilization ratio, memory use amount, and disk use amount) required for the configuration change of a targeted server node 30, the configuration change instruction information 70 that the configuration change device 40 received in step ST-11, and the amounts of resources (CPU utilization ratio, memory use amount, and disk use amount) required for a cooperative server node 30. The configuration change instruction information 70 is required when a command is input from an input device to start a process in step ST-11.

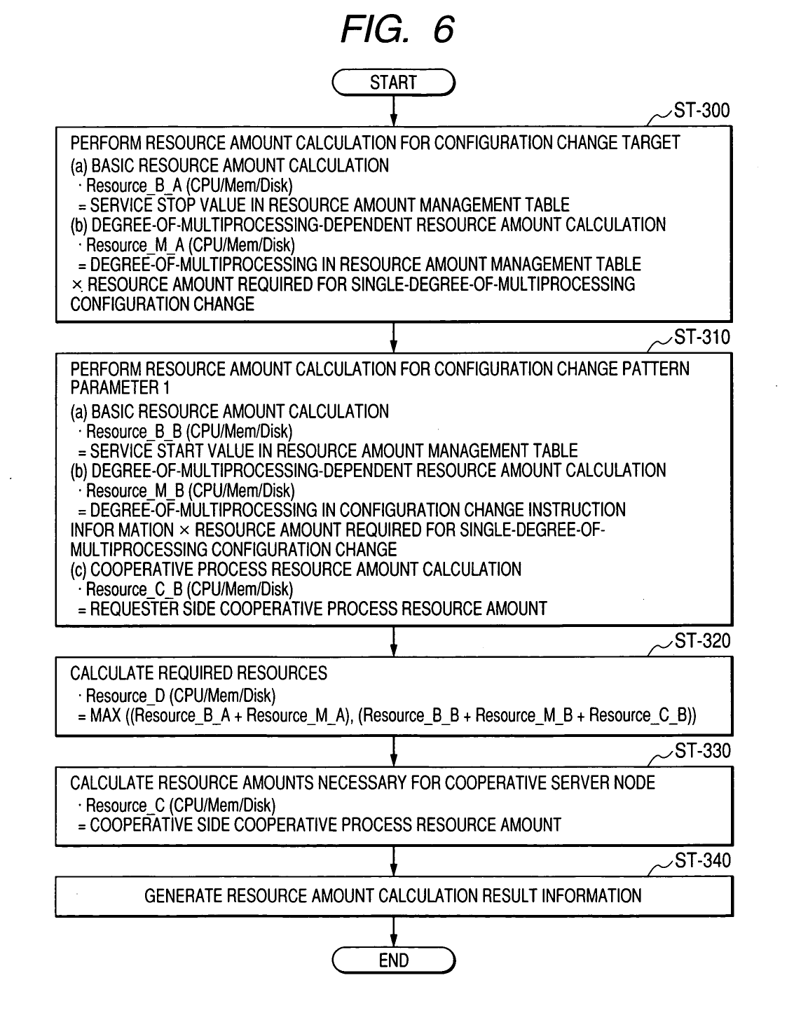

FIG. 6 is a flowchart illustrating the details of the processing step (step ST-12) that is performed to calculate the amounts of resources required for a pattern 1 configuration change.

The resource amount calculation unit 41 first calculates the resource amount concerning the configuration change target 71, which is included in the configuration change instruction information 70 (step ST-300). More specifically, the resource amount calculation unit 41 searches the resource amount management table 100 by using the service name/server node name stored as the configuration change target 71 as a key, acquires the service stop value for the associated service/server node, and handles the acquired value as a basic resource amount (Resource_B_A). The term “mem” is an abbreviation for the word “memory”. Further, the degree of multiprocessing in the resource amount management table 100 is multiplied by the “resource amount required for single-degree-of-multiprocessing configuration change” to calculate a resource amount (Resource_M_A) that relates to the service to be stopped and depends on the degree of multiprocessing.

Next, the resource amount calculation unit 41 calculates the resource amount concerning configuration change parameter 1 (73) in the configuration change instruction information 70 (step ST-310). More specifically, the resource amount calculation unit 41 searches the resource amount management table 100 by using the service name stored as configuration change parameter 1 (73) and the associated server node name as a key, acquires the service start value for the associated service/server node, and handles the acquired value as a basic resource amount (Resource_B_B). Further, the degree-of-multiprocessing stored as configuration change parameter 2 (74) in the configuration change instruction information 70 is multiplied by the “resource amount required for single-degree-of-multiprocessing configuration change” 140 for the associated service/server node in the resource amount management table 100 to calculate a resource amount (Resource_M_B) that relates to the service to be started and depends on the degree of multiprocessing. Furthermore, when the service/server node to be started needs the resources for a cooperative process, the amounts of “resources for cooperative process” for the associated service/server node are acquired from the resource amount management table 100 and used as the amounts of resources for a cooperative process (Resource_C_B).

Next, the resource amount calculation unit 41 calculates the required resource amount concerning the server node 30 targeted for a configuration change (step ST-320). The required resource amount (Resource_D) is either the total resource amount (Resource_B_A+Resource_M_A) concerning the configuration change target 71 or the total resource amount (Resource_B_B+Resource_M_B+Resource_C_B) concerning configuration change parameter 1 (73), whichever is larger. Since the service stop and service start functions are serially exercised, the larger amount should be used as the required resource amount.

Next, if the service/cooperative server node requires the resources for a cooperative process, the resource amount calculation unit 41 acquires the amounts of “resources for a cooperative process” concerning the service/server node from the resource amount management table 100, and handles the acquired information as the amounts of resources for a cooperative process (Resource_C) on the cooperative side (step ST-330).

Next, the resource amount calculation unit 41 generates the resource amount calculation result information 80 from the calculation results obtained in steps ST-320 and ST-330 (step ST-340).

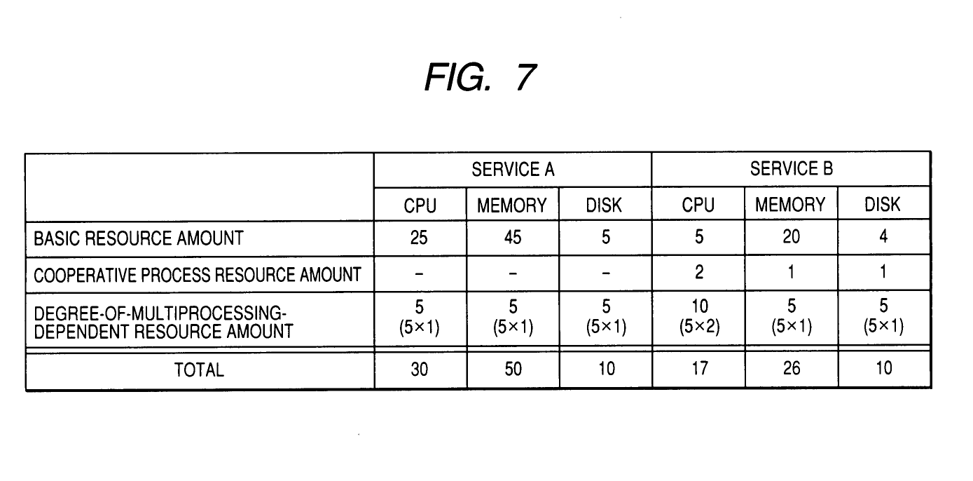

When the typical data in the resource amount management table 100 shown in FIG. 4 is used to perform step ST-300 and step ST-310 calculations, the values shown in FIG. 7 result.

When step ST-320 is applied to the data shown in FIG. 7, the following results are obtained:
CPU utilization ratio: 30%
Memory use amount: 50 MB
Disk use amount: 10 MB

The following processing results are obtained in step ST-330:
CPU utilization ratio: 2%
Memory use amount: 1 MB
Disk use amount: 1 MB

As regards configuration change pattern 2, only the calculation in step ST-310 shown in FIG. 7 should be performed for service A. As regards pattern 3, the required resource amount is determined by performing the calculation in step ST-300 for service A.

As regards pattern 4, the total resource amount for server node 30-1, which is determined in step ST-300, is the required resource amount; and the total resource amount for server node 30-2, which is determined in step ST-310, is the required resource amount. Further, the amounts of resources for cooperative process, which are determined in step ST-330, are added to server node 30-2. A double on-line state in which service A runs on both server node 30-1 and server node 30-2 should be avoided. The double on-line state can be avoided by using the scheduled change-over command of a service that is offered by common cluster software.

As regards pattern 5, the required resource amount should be calculated with (b) in step ST-310 applied to the increase in the degree of multiprocessing and (b) in step ST-300 applied to the decrease in the degree of multiprocessing.

As described above, a configuration change command can be input from the configuration change device 40 or from an input device of a server node 30 in which the configuration change device 40 is incorporated. This command contains the configuration change instruction information 70. When an operator enters this command, the configuration change device 40 starts a process in step ST-11. The processing steps to be performed subsequently are as indicated in FIG. 2.

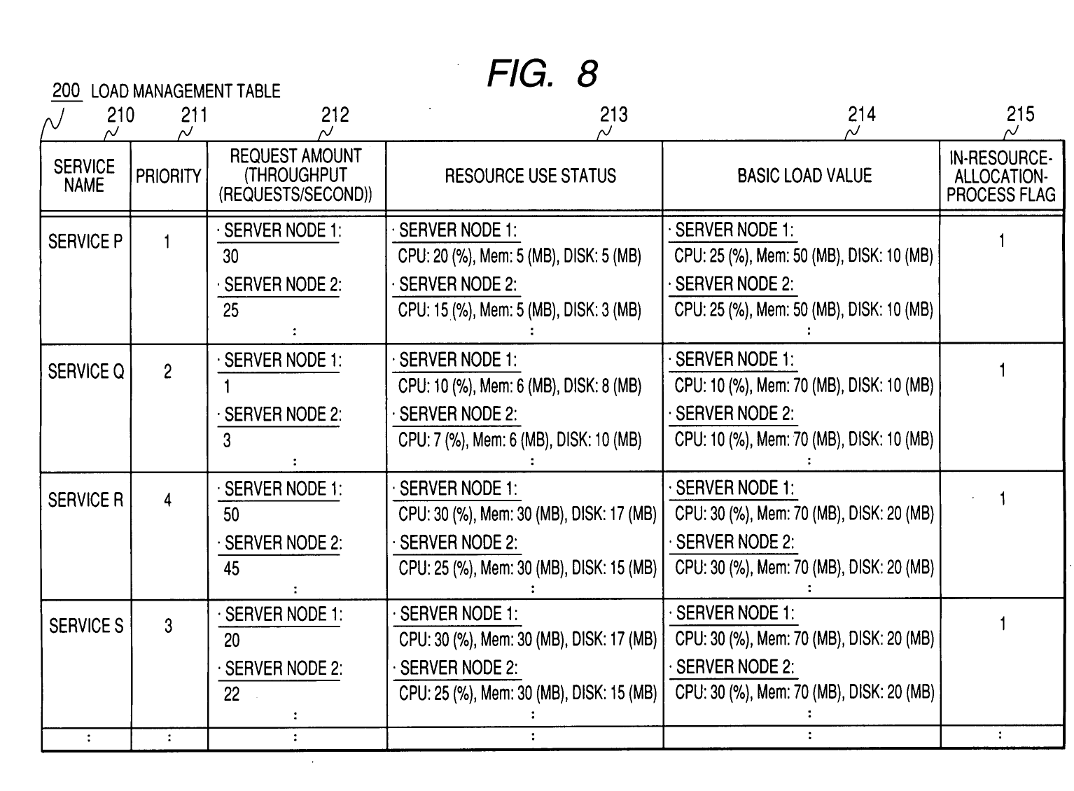

FIG. 8 shows a typical data structure of the load management table 200. The service name 210 is the identifier of a service. The priority 211 is the priority of the service. The request amount 212 indicates the number of requests per second, and the current throughput of a service running on a server node 30 is stored. The resource use status 213 indicates the current resource use of the service. The basic load value 214 is a basic load value for the service. The in-resource-allocation-process flag 215 takes the value 1 or the value 0 to indicate whether step ST-4 is being performed to change the basic load value for the service in order to allocate configuration change resources.

According to the load management table 200 shown in FIG. 8, services P to S are running on a server node that makes a configuration change. As regards the priority 211, the value 1 represents the highest priority, and the priority decreases with an increase in the value. Therefore, service R has the lowest priority as indicated below:

Priority order: Service P>service Q>service S>service R

If only the priority order is to be complied with, the basic load value for service R should be changed. However, it is obvious that service R involves the largest current request amount (throughput (requests/second) and is frequently requested in the indicated time zone. Therefore, if the target service is merely determined according to only the priority, and its basic load value is decreased to reduce the request amount, the quality of the service offered to a client terminal 10 may be adversely affected. (However, in a situation where a function is available for changing the individual service priority and basic load value for each time zone in accordance with a business schedule and peak periods, the influence upon a client 10 may be insignificant even if the service targeted for a basic load value change is determined according to the priority only.)

Therefore, as an example for resource allocation necessary for a configuration change, it is possible to calculate the ratio of the resource amount to be allocated for each service to the required resource amount, calculate the resource amount to be allocated for each service, and achieve resource allocation from all the services running on a server node targeted for a configuration change, in accordance with the request amount and service priority.

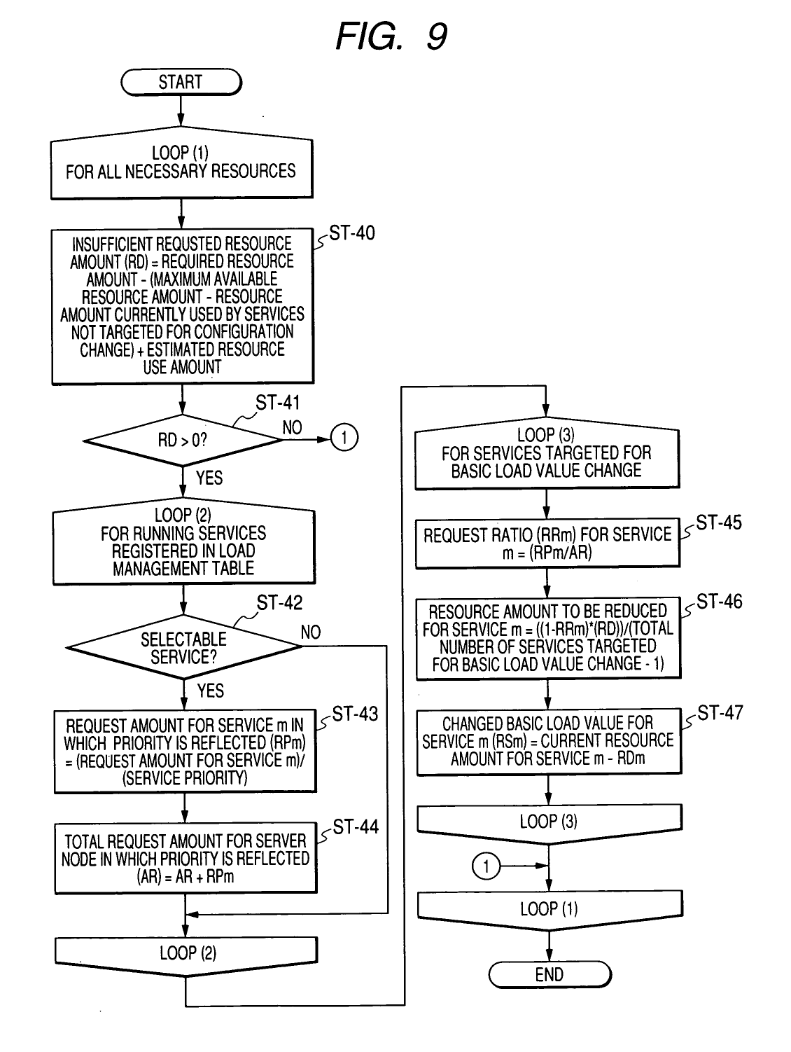

FIG. 9 is a flowchart illustrating the details of the process performed in step ST-4, which is shown in FIG. 2. First of all, the basic load value change unit 22 examines the resource amount necessary for the configuration change of a target server node, and determines the resource amount that needs to be actually allocated by changing the basic load value of each service (step ST-40).

Insufficient requested resource amount (RD)=required resource amount−(maximum available resource amount−resource amount currently used by services that are not targeted for a configuration change)+(estimated resource use amount)

The “maximum available resource amount” in the above equation is the resource amount that can be allocated to the services running on a server node. As regards the CPU utilization ratio, the “maximum available resource amount” is determined by subtracting the amount used by the OS or other system from the total available resource amount.

The “resource amount currently used by services that are not targeted for a configuration change” is subtracted from the “maximum available resource amount”. The “estimated resource use amount” is then added. Eventually, the resource amount that cannot be covered by the unoccupied resources on a server node is calculated as the “insufficient requested resource amount (RD)”.

The “resource amount currently used by services that are not targeted for a configuration change” is determined by subtracting from the total resource amount the resource amount currently used by a running service that is targeted for a configuration change. It is, for instance, the sum of the resource amounts currently used for services P to S as indicated in the load management table 200 shown in FIG. 8.
CPU: 90%
Memory: 71 MB
Disk: 47 MB

The “estimated resource use amount” is, for instance, a statistically predicted amount of resource use during a configuration change process. It is a margin value that is used to avoid a situation where the allocated resource amount cannot cover a sudden increase in the amount of requests from clients during a configuration change process. An extra amount may be added to the required resource amount in step ST-12 instead of using the estimated resource use amount.

If the “insufficient requested resource amount (RD)” is not greater than 0, the basic load value change unit 22 concludes that the available resource amount will suffice. Therefore, the basic load value need not be changed for resource allocation (the query in step ST-41 is answered “No”).

According to the load management table 200 shown in FIG. 8, when the resource amounts available for the services on server node 30-1 are shown below, the resource that needs to be allocated by making a basic load value change is limited to the CPU.
Maximum resource amounts available for server node 30-1:
   CPU: 95%
   Memory: 300 MB
   Disk: 98 MB
Insufficient required resource amount RD (CPU)=30−(95−90)=25
Insufficient required resource amount RD (memory)=50−(300−71)+100 (estimated amount)=−79
Insufficient required resource amount RD (disk)=10−(98−47)+40 (estimated amount)=−1

### However, it is assumed that the estimated resource use amount for the CPU is 0.

The basic load value change unit 22 repeatedly performs steps ST-42 to ST-44 on every running service registered in the load management table 200. The basic load value change unit 22 judges whether a running service is selectable (step ST-42). The selectable services are services targeted for a basic load value change, excluding the services targeted for a configuration change, like service A, and special services not targeted for a basic load value change. If a running service is not selectable, the basic load value change unit 22 skips steps ST-43 and ST-44. If a running service is selectable, the basic load value change unit 22 uses the following equation to determine the request amount in which the priority is reflected, as the request amount for a service running on the server node targeted for a configuration change (step ST-43).

Request amount for service m in which the priority is reflected (RPm)=(request amount for service m)/(priority of service m)

Next, the basic load value change unit 22 adds the request amount for service m (RPm) to the total request amount for the server node, and determines the total request amount in which the priority is reflected (AR) (step ST-44).

Total request amount for the server node in which the priority is reflected (AR)=AR+RPm

According to the load management table 200 shown in FIG. 8, the following values are obtained for server node 30-1 as a result of the above calculation:

Service P: RP(P)=30/1=30

Service Q: RP(Q)=1/2=0.5

Service R: RP(R)=50/4=12.5

Service S: RP(S)=20/3=6.6

AR=49.6

Next, the basic load value change unit 22 repeatedly performs steps ST-45 to ST-47 on every service targeted for a basic load value change. The basic load value change unit 22 determines the request ratio for service m in accordance with the request amount (RPm) determined in step ST-43 (step ST-45).

Request ratio (RRm) for service m=(RPm/AR)

Next, the basic load value change unit 22 uses the following equation and the above ratio to calculate the resource amount to be reduced for service m, which is a part of the requested resource amount (step ST-46):

Resource amount to be reduced for service m(RDm)=((1−RRm)×RD)/(number of services targeted for a basic load value change−1)

### In other words, the insufficient requested resource amount RD is uniformly covered by all services targeted for a change in accordance with the request ratio (RRm).

As a result of the above calculations, the load management table 200 shown in FIG. 8 indicates that the following resource amounts should be reduced for the services:

### Service P: RR(P)=RP(P)/AR=0.6

### Service Q: RR(Q)=RP(Q)/AR=0.01

### Service R: RR(R)=RP(R)/AR=0.25

### Service S: RR(S)=RP(S)/AR=0.13

### Service P: RD(P)=((1−RR(P))×RD(CPU))/(4−1)=3.29

### Service Q: RD(Q)=((1−RR(Q))×RD(CPU))/(4×1)=8.25

### Service R: RD(R)=((1−RR(P))×RD(CPU))/(4−1)=6.23

### Service S: RD(S)=((1−RR(S))×RD(CPU))/(4−1)=7.22

Next, the basic load value change unit 22 determines a changed basic load value for service m (RSm) from the resource amounts to be reduced for the services (step ST-47).

Changed basic load value for service m(RSm)=current resource amount for service m−RDm

As a result of the above calculations, the load management table 200 shown in FIG. 8 indicates that the changed basic load values for the services are as follows:

### Service P: RS(P)=20−RD(P)=16.71%

### Service Q: RS(Q)=10−RD(Q)=1.75%

### Service R: RS(R)=30−RD(R)=23.77%

### Service S: RS(S)=30−RD(S)=22.78%

The basic load value change unit 22 repeats loop (1) to perform the process shown in FIG. 9 for all necessary resources. The basic load value change unit 22 also performs the process shown in FIG. 9 on a cooperative server node 30.

When the load management table 200 can also be referenced by the configuration change device 40, the configuration change device 40 can also perform the basic load value calculation step (step ST-4).

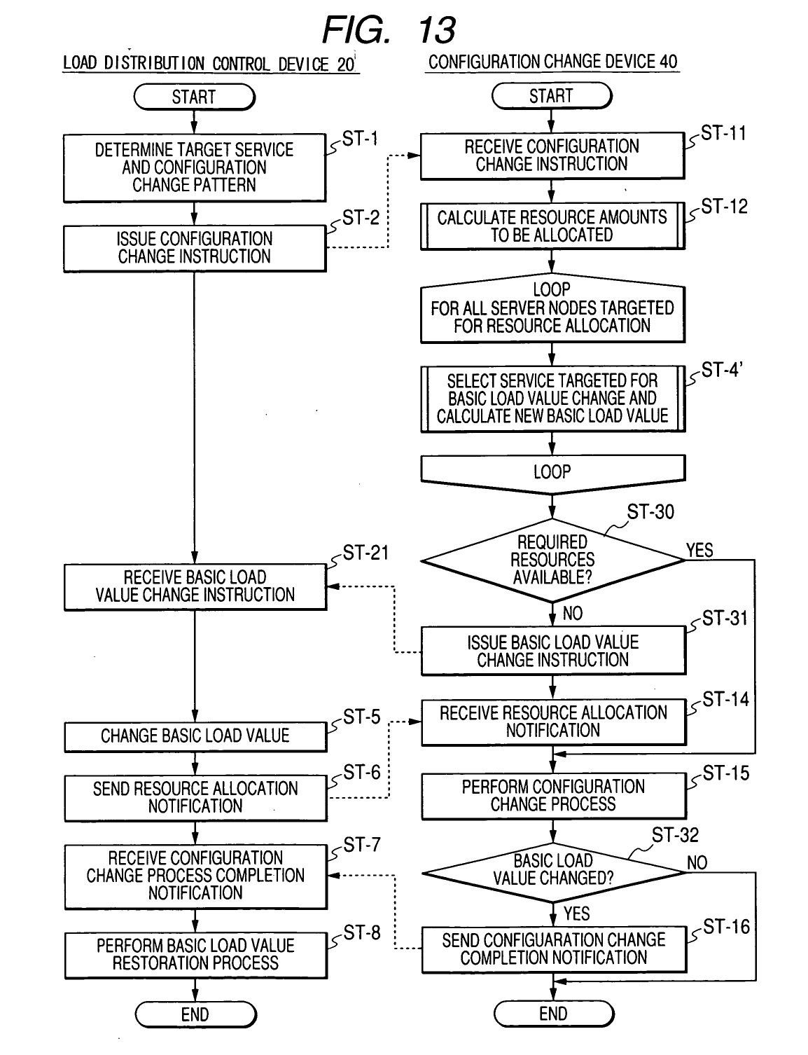

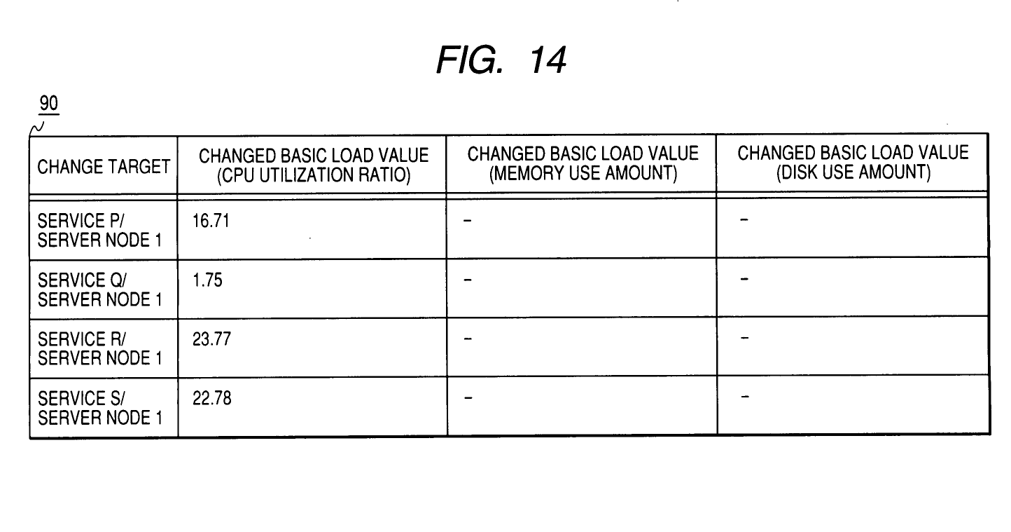

FIG. 13 is a flowchart illustrating a configuration change procedure that is followed when the configuration change device 40 performs the basic load value calculation step. After completion of the basic load value calculation step (step ST-4′), step ST-30 is performed to judge whether there are resources necessary for a configuration change. If the resources necessary for a configuration change are not available (if the query in step ST-30 is answered “No”), step ST-31 is performed to issue a basic load value change instruction to the load distribution control device 20. FIG. 14 shows a typical data structure of basic load value information that is used when step ST-31 is performed to issue a basic load value change instruction. The data in FIG. 14 are based on the above calculation results. If, on the other hand, there are resources necessary for a configuration change (if the query in step ST-30 is answered “Yes”), a configuration change process is immediately performed (step ST-15). After completion of the configuration change process, step ST-32 is performed to judge whether a basic load value change is made to allocate the resources necessary for the configuration change. This judgment is formulated depending on whether steps ST-31 and ST-14 have been completed. If the basic load value is changed, step ST-16 is performed to notify the load distribution control device 20 of configuration change process completion.

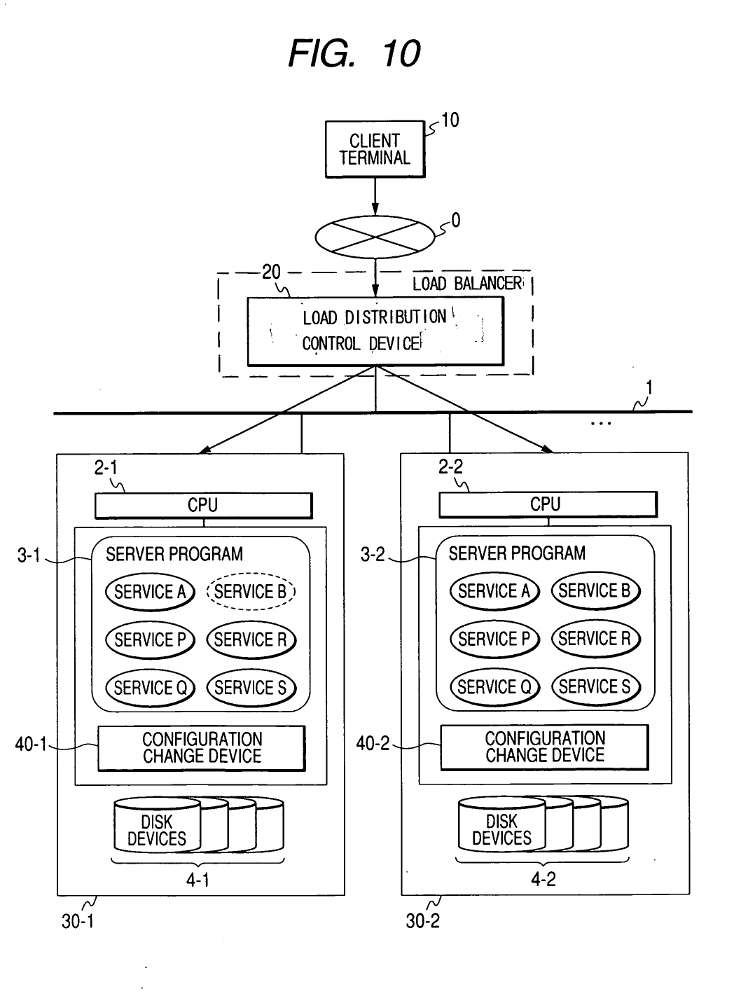

The configuration change device 40 may be configured as an independent device as described earlier. However, it may also be incorporated in all server nodes 30 that constitute a cluster system as shown in FIG. 10, and operated in each server node 30. In such a situation, the configuration change devices 40 synchronize with each other, for instance, by sharing the information in the resource amount management table 100. In the example shown in FIG. 10, the resource amount management table 100 is stored on the disk device 4 of each server node 30.

As described above, the present embodiment can allocate resources necessary for a service-related configuration change by decreasing, as needed, the basic load value of a service running on a server node 30 targeted for the configuration change. Therefore, the present embodiment can make such a configuration change immediately.

Further, the present embodiment can prevent the load balance from being impaired by request distribution by the request distribution unit 23 during a configuration change process, and offer consistent services to clients by equally decreasing the basic load values for services running on a server node 30 targeted for a configuration change as needed in accordance with the service grade.

As an application of the present invention, a specific batch operation that is to be performed with resources allocated prior to a request from a client can be executed via the configuration change device 40 according to the present embodiment to temporarily allocate the resources necessary for a batch process. This makes it possible to rapidly execute a batch operation whose execution time is limited, and prevent a process from being delayed due to resource insufficiency.

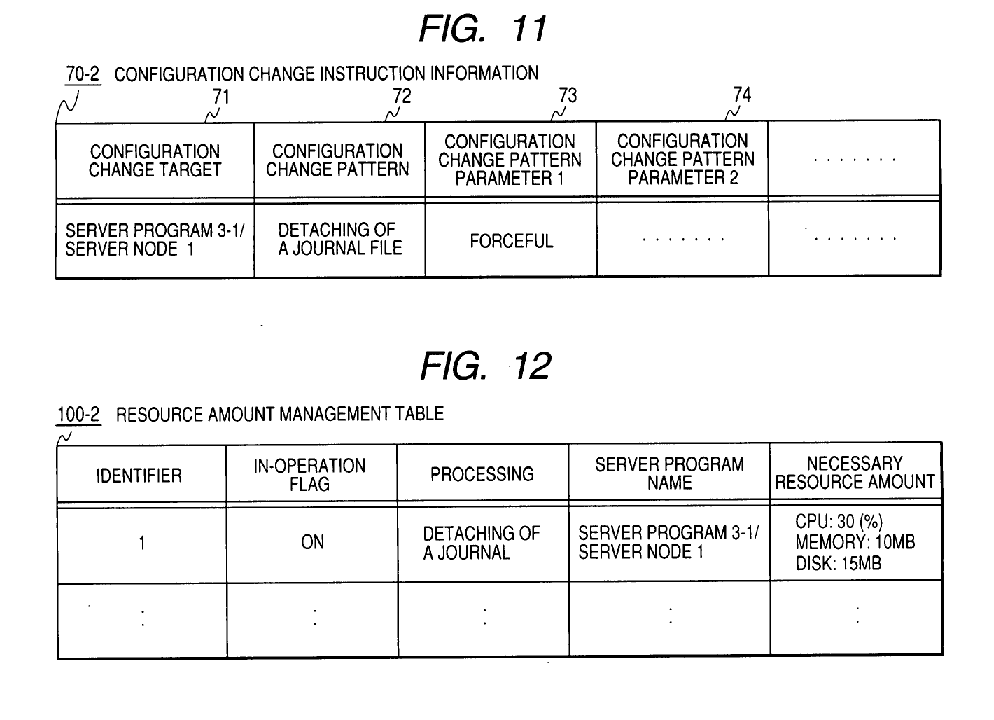

As another application of the present invention, request flow rate control can be exercised even when a server program for offering on-line services performs an internal process. The internal process includes a process, e.g., a process for detaching a journal file that is used in an on-line state, that considerably consumes resources. When a journal file is to be detached, a server's daemon, for example, issues a configuration change instruction to the configuration change device 40. In step ST-11, which is shown in FIG. 2, the configuration change instruction information 70-2 shown in FIG. 11 is conveyed for instruction purposes. A flag can be designated as configuration change pattern parameter 1 (73) to specify a forced execution as an execution timing with “server program 3-1/server node 1” set as the configuration change target 71 of the configuration change instruction information 70-2 and “detaching of a journal file” set as the configuration change pattern 72. In step ST-12 in which the resource amount necessary for a configuration change is calculated, the necessary resource amount can be calculated as far as a resource amount management table 100-2 for internal processing is prepared as indicated in FIG. 12. After the configuration change instruction is issued, the same processing steps (steps ST-3 to ST-16) as indicated in FIG. 2 are performed.

What is claimed is:

1. A load distribution control method for use in a load distribution control apparatus that includes a plurality of server nodes in which a plurality of business programs for offering services run, and exercises control so that requests received from client terminals are distributed to the plurality of server nodes in order to distribute the load on the server nodes, the method executed on the load distribution control apparatus comprising the steps of:
referencing resource amount management information, in which resource amounts necessary for a configuration change is set on an individual resource basis, and calculating necessary resource amounts when a configuration change involving a service-start or service-stop is to be made;
referencing load management information that stores the use of each resource in relation to various combinations of the identifier of a running service and the identifier of a server node, and checking a server node requiring the calculated resource amounts to judge whether any resources are insufficient for a configuration change process; and
making any insufficient resource amounts available and effecting the configuration change.

2. The load distribution control method according to claim 1, wherein the configuration change is effected when no resources are insufficient.

3. The load distribution control method according to claim 1, wherein the configuration change is such that a plurality of patterns, including a pattern involving a service start or service stop, are set to calculate necessary resource amounts in accordance with each pattern.

4. The load distribution control method according to claim 1, further comprising the steps of:
referencing a resource use status recorded in the load management information to judge whether the configuration change is needed; and
determining a target service that needs the configuration change.

5. The load distribution control method according to claim 3, further comprising the step of:
receiving an instruction for the configuration change and the information about a target service and the pattern via an input device connected to the load distribution control apparatus.

6. The load distribution control method according to claim 1, wherein the load management information holds a basic load value for each resource in accordance with the resource use status, the method further comprising the steps of:
performing setup to decrease the basic load value for a service running in a server node that needs resources for the configuration change in accordance with the insufficient resource amounts when the insufficient resource amounts are to be allocated; and
restoring the decreased basic load value to the previous value after the configuration change.

7. The load distribution control method according to claim 6, wherein the running service covers the decrease in the basic load value in accordance with request amount throughput and service priority.

8. A load distribution control apparatus that includes a plurality of server nodes in which a plurality of business programs for offering services run, and exercises control so that requests received from client terminals are distributed to the plurality of server nodes in order to distribute the load on the server nodes, the apparatus comprising:
a resource amount management table for setting resource amounts necessary for a configuration change on an individual resource basis;
a load management table for storing the use of each resource in relation to various combinations of the identifier of a running service and the identifier of a server node;
means for referencing the resource amount management table to calculate necessary resource amounts when a configuration change involving a service-start or service stop is to be made;
means for checking the server node that requires the resource amounts calculated by referencing the load management table, and judging whether any resources are insufficient for the configuration change;
means for making insufficient resource amounts available if any resources are insufficient; and
means for effecting the configuration change after the insufficient resource amounts are made available.

9. A cluster system comprising:
a group of server nodes in each of which a plurality of service-offering business programs run; and
a load distribution control device that is configured as an independent computer or incorporated in the server nodes,
wherein the load distribution control device includes
means for distributing requests received from client terminals to the plurality of server nodes in order to distribute the load on the server nodes,
a resource amount management table for setting resource amounts necessary for a configuration change on an individual resource basis,
a load management table for storing the use of each resource in relation to various combinations of the identifier of a running service and the identifier of a server node,
means for referencing the resource amount management table to calculate necessary resource amounts when a configuration change involving a service-start or service-stop is to be made,
means for checking the server node that requires the resource amounts calculated by referencing the load management table, and judging whether any resources are insufficient for the configuration change,
means for making insufficient resource amounts available if any resources are insufficient, and
means for effecting the configuration change after the insufficient resource amounts are made available.

10. The cluster system according to claim 9, wherein the configuration change is effected when no resources are insufficient.

11. The cluster system according to claim 9, wherein the configuration change is such that a plurality of patterns, including a pattern involving a service start or service stop, are set to calculate necessary resource amounts in accordance with each pattern.

12. The cluster system according to claim 9, wherein the load distribution control device references a resource use status recorded in the load management information to judge whether the configuration change is needed; and determines a target service that needs the configuration change.

13. The cluster system according to claim 9, wherein the load distribution control device receives an instruction for the configuration change and the information about a target service and the pattern via an input device connected to the load distribution control device.

14. The cluster system according to claim 9, wherein the load management table holds a basic load value for each resource in accordance with the resource use status;
wherein the load distribution control device includes means for performing setup to decrease the basic load value for a service running in a server node that needs resources for the configuration change in accordance with the insufficient resource amounts when the insufficient resource amounts are to be allocated; and
means for restoring the decreased basic load value to the previous value after the configuration change.

15. The cluster system according to claim 14, wherein the running service covers the decrease in the basic load value in accordance with request amount throughput and service priority.

16. A program for controlling a cluster system that has a plurality of server nodes in which a plurality of business programs for offering services run, said program causing a computer to exercise control so that requests received from client terminals are distributed to the plurality of server nodes in order to distribute the load on the server nodes, said program causing the computer to realize the functions of:
referencing resource amount management information, which holds information of resource amounts necessary for a configuration change on an individual resource basis, to calculate necessary resource amounts when a configuration change involving a service-start or service-stop is to be made;
referencing load management information, which stores the use of each resource in relation to various combinations of the identifier of a running service and the identifier of a server node, checking the server node that requires the calculated resource amounts, and judging whether any resources are insufficient for the configuration change; and
making insufficient resource amounts available if any resources are insufficient, and effecting the configuration change after the insufficient resource amounts are made available.

17. The program according to claim 16, wherein the configuration change is effected when no resources are insufficient.

18. The program according to claim 16, wherein the configuration change is such that a plurality of patterns, including a pattern involving a service start or service stop, are set to calculate necessary resource amounts in accordance with each pattern.

19. The program according to claim 16, further causing the computer to realize the functions of:
referencing a resource use status recorded in the load management information to judge whether the configuration change is needed; and
determining a target service that needs the configuration change.

20. The program according to claim 18, further causing the computer to realize the function of:
receiving an instruction for the configuration change and the information about a target service and the pattern via an input device connected to the computer.
